(19) United States
(12) Patent Application Publication
(10) Pub. No.: US 2011/0283627 A1
(43) Pub. Date: Nov. 24, 2011

(54) SMOKE GUARD DEVICE AND ACCESSORIES

(75) Inventor: Alan Shaw, Lockport, NY (US)

(73) Assignee: BUTTERFLY SAFETY PRODUCTS LLC, Buffalo, NY (US)

(21) Appl. No.: 13/113,253

(22) Filed: May 23, 2011

Related U.S. Application Data
(60) Provisional application No. 61/347,401, filed on May 22, 2010.

(51) Int. Cl. E06B 7/22; F21V 33/00; B65D 6/28; H01F 7/00; F16B 47/00

(52) U.S. Cl. 49/478.1; 49/475.1; 220/6; 362/253

(57) ABSTRACT

A smoke-barrier device for under-door gaps is taught. A basic barrier comprises a unit of expandable/compressible material covered by one end of a length of fire-resistant and smoke and gas impermeable material, and is sized to completely seal the mandated gap beneath doors in the event of a fire. Another style includes magnetic material on the other end of the length of fire-resistant, moisture and gas impermeable material to further adhere the barrier to a metal door. Intumescent material may be fixed on the central part of the length of fire-resistant, moisture and gas impermeable material. The device is sized to fit commercial and private doors spaces and is offered in a kit including tape to place about top and sides openings of a door, luminescent tape to be placed on a window in the room, and a flashlight of various styles. The fire-resistant material may also be water impermeable.

### CROSS-REFERENCE TO RELATED APPLICATIONS

This Non-Provisional Application claims the benefit of Provisional Application No. 61/347,401 filed May 22, 2010.

### STATEMENT REGARDING FEDERALLY SPONSORED RESEARCH OR DEVELOPMENT

### REFERENCE TO SEQUENCE LISTING, A TABLE OR A COMPUTER PROGRAM LISTING COMPACT DISK APPENDIX

Not Applicable

### BACKGROUND OF THE INVENTION

The present invention relates generally to smoke guards and more particularly to smoke guards that completely block the gap between the bottom of a door and the floor to prevent smoke and fire from entering a room through that gap in the event of a fire and to smoke guard accessories that further protect people trapped in a room during a fire.

The background information discussed below is presented to better illustrate the novelty and usefulness of the present invention. This background information is not admitted prior art.

As a safeguard against the threats posed by a fire, ideally, there should always be two means of exit from a room. In commercial buildings, especially in high rise buildings, this is often not the case. When there is only one exit from a closed room and a fire alarm sounds, before opening the door in an attempt to exit the building, the first thing one is advised to do is to check the temperature of the door leading out of the room. If the door feels cool all the way to the bottom of the door and if no smoke is leaking into the room from openings about the door, then the door should be slowly opened to check if there is a safe path to exit the building.

If the door is warm or hot to the touch, it is likely that the fire is too close to safely attempt opening the door. In this case, as quickly as possible, one should seal all of the openings around the door to prevent smoke and fire from coming into the room from the space at the bottom of the door. Smoke and poisonous gases are the number one killer in a fire, so preventing smoke from entering the room is of utmost importance. Most doors, especially doors in hotels and office buildings, have mandated gaps between the bottom of the door and the floor. Often, it is suggested to use a wet towel to plug the open space at the bottom of the door and, lacking a wet towel, anything that is available should be used. The openings about the sides of the door should also be sealed. It is advised to do this by using masking tape or the like.

If there is a fire and there is a window that provides a safe exit, it should be used to exit the building. It is often the case that windows are the windows of a high-rise apartment or office building and unless there is a fire-escape within reach, window exist is not a viable option. Aerial ladders on fire trucks are about 100 feet in length, however, it is not usual for fire truck ladders to reach to that height, even when extended, because of the distance from the building the fire truck must be parked. If fire-fighters are unable to reach a room from the outside, persons in the room will have to stay in the room and try to keep the smoke and fire from entering the room. A telephone or a cell phone should be used to alert others to the situation. Although tempting, there is real danger in breaking a window to call for help as an open window will provide a draft that may encourage the fire.

### SUMMARY

When the present Inventor realized that: (1) most doors are mandated to have a gap of about an inch between the bottom of the door and the floor, (2) that this gap presents an opening for smoke, fire, and dangerous gases to enter a room even when the door is closed the floor, and (3) in the event of a fire having a recommended “wet towel” available to stuff into the gap is unlikely, he devised a set of inventive principles to provide a device for sealing the gap beneath a door.

The invention principles taught herein provide for a smoke guard device constructed of compressible/expandable material covered by fire resistant cloth, said device so arranged that when inserted into a gap between the bottom of the door and the floor prevents any smoke from traversing the gap. The device, referred to as a “smoke guard”, is easy to use, fills the space entirely, will not burn, and is impervious to smoke and gas. The set of invention principles, as described herein, provides for various styles and sizes of the device and also provides for smoke guard accessories. One accessory comprises a set of self-adhering intumescent material strips to be placed over side and top of door openings to further secure a closed room from smoke. Once a room is secured from the entry of smoke, gas, and flame, the smoke guard package of accessories includes reflective tape to be adhered to a window to give notice to emergency rescue personnel that there is someone in that room that needs to be rescued, a light means, such as a flashlight, and/or a glow-light that lasts 12 hours without a battery or other power.

One example of the smoke guard is designed for use with a metal door and consists of a length of high material rated to withstand high temperature and that is smoke, gas and moisture impermeable, where one end of the length of material is wrapped about and fixed to a piece of memory foam with the other end of the length of cloth being wrapped about and fixed to a length of magnetic material. The memory foam end is easily positioned within the space between the bottom of the door and the floor keeping the end with the magnet lying on the floor. The immediate expansion of the foam, once the guard is positioned in the open space, assures that the space is completely filled and blocked. To double the protection of the smoke blocking foam containing end that is stuffed under the door and to assure that the smoke guard is not blown out of its position by force of air created by the fire, the magnet end of the smoke guard is lifted up and placed against the door so that the magnet holds the device tight to the door.

Another example of the present invention is designed for use with a wooden door, and like the example that is designed for a metal door, the example designed for use with a wooden door also consists of a length of high temperature material that is smoke, gas and water impermeable, where a first end of the length of material is wrapped about and fixed to a piece of memory foam with a second end of the length of cloth being wrapped about and fixed to a length of magnet. The memory foam end is easily positioned within the space between the bottom of the door and the floor keeping the end with the magnet lying on the floor. This example comes with a strip of magnetic metal that is affixed to the inside of the wooden door near the bottom of the door so that once the smoke guard is in place, there is a magnetic strip to accept the magnetic end of the smoke guard. Alternatively, the device is provided with a strip of tape to adhere the second end to the door to further enhance the life and effectiveness of the device.

Yet another way to use the present invention is to have it installed within the body of the door so that the bottom edge of the invention is parallel and in the same plane as the bottom of the door. In this embodiment, when the smoke guard is needed, a user simply has to pull down on the set of handles that extend through the inner-surface of the door and are attached to a metal plate that forms the top surface of the device, to release the device so that when the handles are activated, the smoke guard is pulled down into the space between the bottom of the door and the floor.

IBC (International Building Code) 2006 mandates that the smoke guards of the present invention be tested in accordance with UL1784 for smoke and draft-control doors having an artificial bottom seal installed across the full width of the bottom of the door assembly. The air leakage rate of the door assembly shall not exceed 3.0 cubic feet per minute per square foot of door opening at 0.10 inch (24.9 Pa) of water for both the ambient temperature test and the elevated temperature exposure test. Additionally, all fire doors with shutter assemblies shall be constructed of any material or assembly of component materials that conforms to the test requirements of Section 715.4.1, 715.4.2 or 715.4.3 and the fire protection rating indicated in Table 715.4. Fire door assemblies and shutters shall be installed in accordance with the provisions of this section and NFPA 80.

### BRIEF DESCRIPTION OF THE DRAWINGS

In order that these and other objects, features, and advantages of the present invention may be more fully comprehended, the invention will now be described, by way of example, with reference to the accompanying drawings, wherein like reference characters indicate like parts throughout the several figures, and in which:

FIG. 1 is a plan view illustrating the basic construction of a smoke guard embodiment of the present invention.

FIG. 2 is a side view of the present invention as illustrated in FIG. 1.

FIG. 3 is a perspective diagrammatic sketch illustrating one way to make the device according to the principles of the present invention.

FIG. 3a is a perspective diagrammatic sketch illustrating a smoke guard device made according to the principles of the present invention.

FIG. 3b is a perspective diagrammatic sketch illustrating a smoke guard device in use according to the principles of the present invention.

FIG. 4 is an elevation view of a wooden door with a magnetic strip attached.

FIG. 5 is a diagrammatic view of an embodiment of the present invention that is installed within the body of the door.

FIG. 6 is a sketch of a wall with a door and window to show the use of the accessories according to the inventive concept.

### REFERENCE CHARACTERS AND PARTS TO WHICH THEY REFER

2 A fold line.
4 A sew line.
6 A fold line.
10 An example of the present invention.
12 High temperature cloth.
13 Area of high temperature cloth 12 onto which foam 18 will be positioned.
14 Two sided-tape.
16 Magnetic material.
18 Compressible/re-expandable material, for example foam.
20 Intumescent.
30 Wooden door.
32 Magnetic strip.
60 Open space at bottom of door.
72 Tape.
74 Iridescent or fluorescent tape.
76 Flashlight.
80 Window.
82 Wall.
100 An example of the present invention.
110 A door with a hollow bottom.
112 Top surface of present invention.
114 Releasing handle.
116 Hollow door volume.

### DEFINITIONS

Attachment materials, as used herein, refers to tapes, double-sided tapes, glues, adhesives, staples, sewing means, pins, and magnets, including any other means, known or yet to be known, to fasten materials together.
Fire retardant foam, as used herein, refers to any lightweight self-expanding materials that when compressed will re-expand and are formulated to contain flame-retardant additives or to be being inherently non-flammable and also may have the properties of low smoke density, low toxic gas emission, low heat release, enhanced chemical and solvent resistance, high levels of structural rigidity, chemical stability, UV-resistance, and will not absorb water.
High-temperature cloth, as used herein, refers to any high-temperature cloth or blanket, that is flexible, strong, protective, and fire-resistant, including but not limited to continuous filament, amorphous silica yarns, polymeric material, fiberglass reinforced polymeric material, high-temperature resistant woven textiles, metallized cloth including stainless steel and aluminum foil, and may also include impermeable material.
High-temperature thread, as used herein, refers to any thread that is fire-resistant or any thread that will not support combustion, such as a ceramic thread.
Impermeable membrane, as used herein, refers to a material that does not allow the passage of a fluid, such as water, other liquids, and/or gases, including smoke. The impermeable material disclosed herein includes a flexible, fluid-impermeable, sealing layer that is used for waterproofing by applying one or more layers of the membrane material onto a surface and/or object to be protected. Such impermeable blanket layers are made of a variety of materials, such as, but not limited to, silicone, fiberglass fabric coated with silicone rubber, coal tar, bitumen and synthetic polymers that are formed as sheet-like substances of desired sealing properties. Material and substance properties of impermeable membranes used herein meet the requirements of any particular structure, building, authority, climate, chemical and physical environment, required durability, cost effectiveness and the like.
Intumescent, as used herein, refers to those materials having properties that cause them to expand (or intumesce) to several times their original size when activated by high temperatures to prevent the spread of flames and smoke to other parts of a building, for example passive fire-seals contain intumescent compounds. The intumescent material is available in many forms and may be, for example an intumescent layer, mat, strip, or paste, such as a caulking material.
Magnetic material, as used herein, refers to materials that are magnetized and create their own persistent magnetic field. Materials that can be magnetized, and, thus, are strongly attracted to a magnet, are called ferromagnetic and include iron, nickel, cobalt, alloys thereof, some alloys of rare earth metals, and some naturally occurring minerals such as lodestone.
Seaming, as used herein, refers to connecting one part to another part, for example where a cloth is folded and the two parts of the cloth that have been brought together by the folding are subsequently “seamed” together along a predetermined line. The seaming may utilize stitching, using an adhesive, stapling, pinning, or any other means that will connect the two parts to each other.

### DETAILED DESCRIPTION

To provide an understanding of the basic structure of the smoke guards made according to the principles of the present invention, we refer now to the drawings. It should be noted that the disclosed invention is disposed to versions in various sizes, such as lengths, widths, and depths to accommodate the variety of sizes of door spaces, in addition to variation in shapes, contents, number and composition of layers, materials, and attachment means. Therefore, the versions described herein are provided with the understanding that the present disclosure is intended as illustrative and is not intended to limit the invention to the versions described.

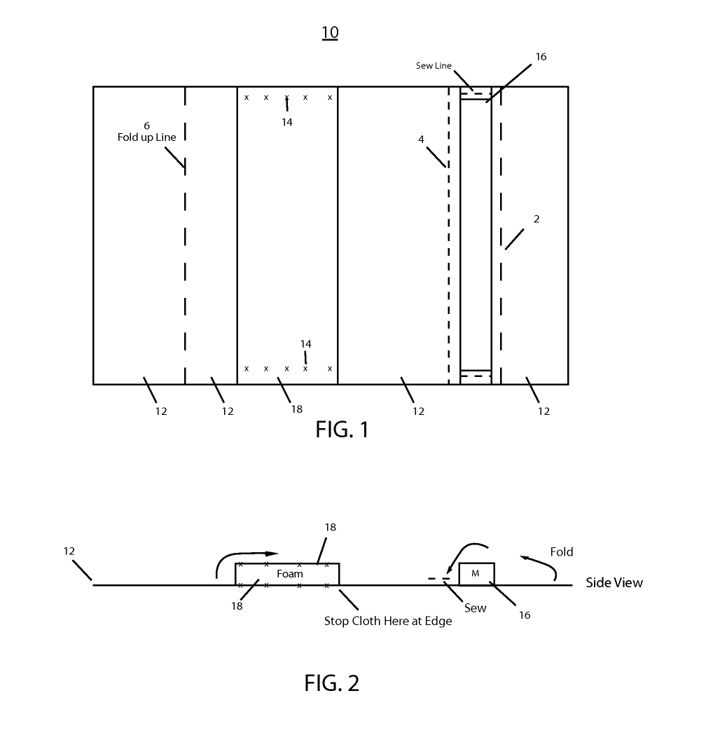

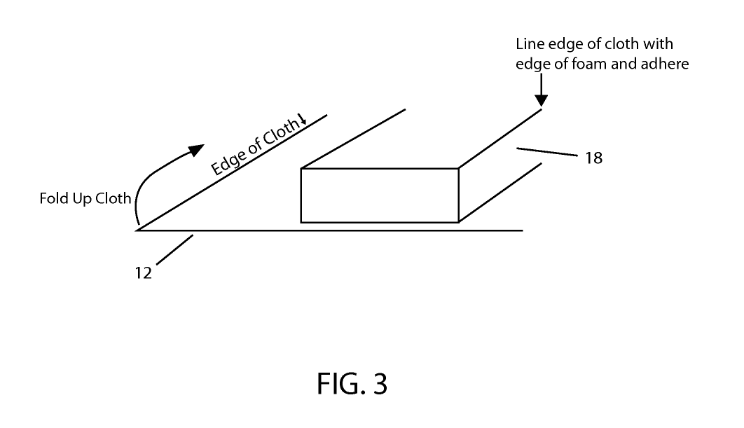

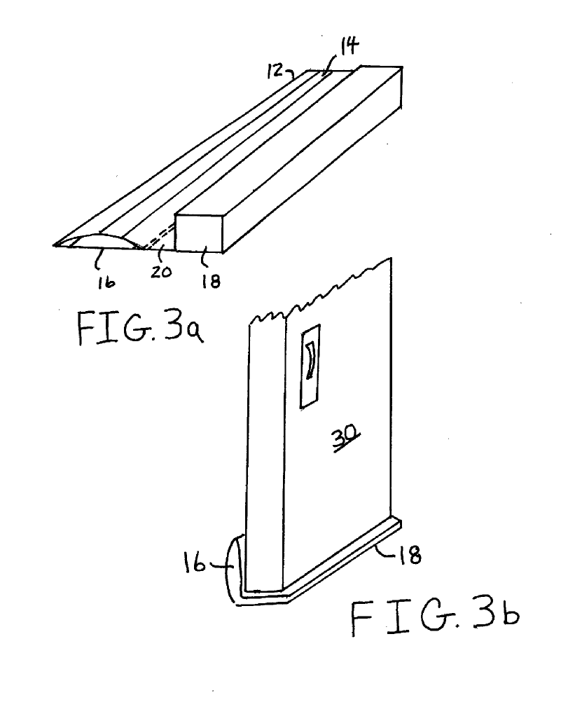

If there is a fire outside of a closed room, it is a recommend to stuff a wet towel into the gap found between the bottom of the door and the floor space to provide at least a temporary safeguard against fire and smoke entering through that space. There are many problems with this; the wet towel must be of the right length, width, and thickness to fill all of the space. Moreover, in order for a towel to be wet there must be a water source in the room. This may be present in many, but not all, hotel rooms, and in some dormitory rooms, but is unlikely to be available in rooms of office buildings and in older hotels that have shared bathroom space. And even when water is available, it is very difficult to stuff a wet towel in the space under a door so that the entire space is blocked, and once the towel is in place, it is only a matter of time before the heat of the fire dries the towel and the towel ignites. Accordingly, the present invention provides a set of inventive principles that enables the manufacture of a device that completely seals the gap space found at the bottom of doors and in the following discussion, the present inventor provides several examples of his inventive concept. FIG. 1, a plan view, and FIG. 2, a side view, illustrate one example of the basic construction of a smoke guard device following the principles of the present invention. Smoke guard device 10 is designed to fill the mandated air-space between the bottom of a closed door and the floor when there is a danger of smoke entering the room. Device 10, illustrated in FIG. 1 as a laid open device, includes a length of high temperature cloth 12 having the width of the door with which the device is to be used. High-temperature cloth 12 is impermeable to smoke, gases, and if desired, to moisture, as well, and is either treated with a fire-retardant or is manufactured of material that is fire-resistant or non-flammable, and is available in all required widths and lengths. At a determined distance from a first end of the length of the cloth, area 13 is set aside for receiving a strip of compressible/re-expandable material, i.e., foam, preferably fire-retardant foam. Although the foam strip may be adhered to the cloth using several different methods, the example provided uses the adhesive method. Across the width of the defined cloth area 13, one surface of a strip of two-sided adhesive tape 14 is adhered to the cloth to receive and adhere one surface of a strip of compressible/re-expandable foam material 18 cut to match the dimensions of cloth area 13. Once the strip of foam material 18 has been adhered to tape 14, a second strip of two-sided adhesive tape 14 is positioned onto the opposing surface of the strip of foam material 18. The first end of the length of high-temperature cloth 12 is then lifted up and folded, along fold line 6, over foam material 18 so that the first end of the cloth completely covers the top and side edges of foam block 18 as indicated by the fold-up arrow illustrated in FIG. 2. The folded-over section of the cover is, in this example, adhered to the second surface of two sided adhesive tape 14 that was positioned on the upper surface of the foam block 18, as is illustrated in the perspective diagrammatic sketch illustrated in FIG. 3. At a determined distance from the second end of the length of cloth 12, magnetic material, such as the strip of magnetic material 16 that is used as an example in this illustration, is position on the cloth across the width of cloth 12, as shown. Magnetic strip 16 is positioned at a distance from the second end of the length of cloth 12 that provides a sufficient length of cloth to fold up, along fold line 2, and over magnetic strip 16 leaving a sufficient amount of cloth on each of the raw edges of the cloth to come into contact with each other after the second end is folded over the magnetic strip so that these edges may be securely stitched closed along sew lines 4 as illustrated by the fold arrows shown in FIG. 2. It is to be understood that the method of attaching the metal to the cloth is by way of example and that other methods, known or yet to be know, may be used. The method used will depend on part on the magnetic material used. The cloth, itself, may be impregnated with a magnetic material, which would completely change the method of attaching a magnet to the material. In this example, magnetic strip 16 happens to be one inch thick, but it is to be understood that the thickness is determined by the properties of the materials being used, such as the magnetic property of a metal door and the corresponding magnetic property of the magnetic strip. This method, of course, is for use with a metal door or a door that has been adapted for magnetic attachment. The smoke guard is now ready for use. The type of foam used may be memory foam, although it is to be understood that the compressible/re-expandable material can be any material that re-expands when compressed. The compressible/re-expandable material, ideally, is impermeable to smoke, gases, and, if desired, to moisture and is either treated with a fire-retardant or is fire resistant or non-flammable. In this illustration, the foam that is used as the compressible/re-expandable material is 1½ inches thick. The thickness, of course, is to be determined by the height of the gap between the bottom of the door and the floor that must be blocked.

As indicated in FIG. 3a, intumescent material 20 may be affixed to cloth 12 in the area of cloth 12 between magnetic strip 16 and compressible/re-expandable material 18. Intumescent material 20 adds an additional level of protection against smoke or fire entering a room. Intumescent materials swell upon exposure to a certain degree of heat to assure that the smoke guard remains in place to securely prevent any ingress of smoke, gas, or fire. Additionally, intumescents are highly endothermic and contain a lot of chemically bound water, such as in the form of hydrates, and as this water is heated and released, it acts to cool adjacent materials, thus prolonging the time of protection.

To use the smoke guard, compressible/re-expandable foam 18 end is compressed and inserted in the space under the door. Once the space is completely filled by this foam containing end of the smoke guard, the compressible/re-expandable foam will re-expand to completely and securely fill all of the door-gap space. Magnetic strip 16 end of the smoke guard is then lifted up off of the floor and magnetically or adhesively 14 adhered to the door (refer to FIG. 3b).

If desired, the smoke guard can be made without the intumescent and without the magnetic strip. The protection offered by cloth 12 in conjunction with compressible/re-expandable material 19 is still significant.

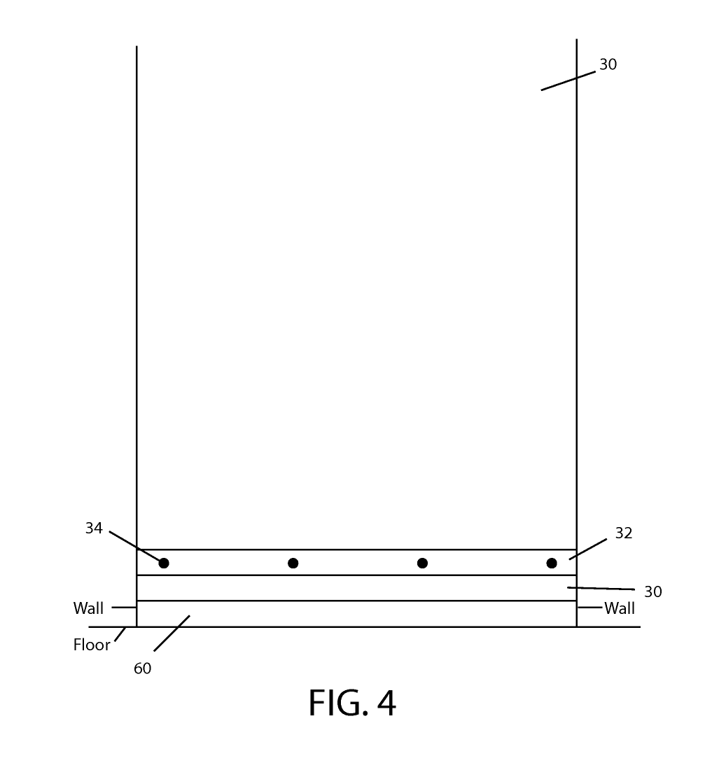

There are many buildings that still have wooden doors. In order for a smoke guard equipped with a magnetic strip to be used to block the mandated gap 60 between the bottom of a wooden door and the floor, in an analogous fashion to the way the device is used with a metal door, the smoke guard is available with a flat magnetic strip that is fashioned for attachment to a wooden door. FIG. 4, an elevation view of a door in place, illustrates how magnetic strip 32 may be attached to wooden door 30. In the example illustrated, magnetic strip 32 is attached to wooden door 30 using attachments such as screws that are installed into screw holes 34 that are pre-drilled through strip 32. It is to be understood that the method of attachment of magnetic strip 32 to door 30 can be any method of attachment, such as double-sided tape pre-applied to the device ready to be used to tape the device to the door. Any others that work to attach the magnetic strip to the door so that it can be used as intended are within the principles of the present invention. As with the metal door, the smoke guard for the wooden may be made and used without the additional safeguards of attaching the device to the door and/or without the use of intumescent. However, each of these added features provides extra protection against the entry of smoke or flames and increases the lifetime of the device during a fire event.

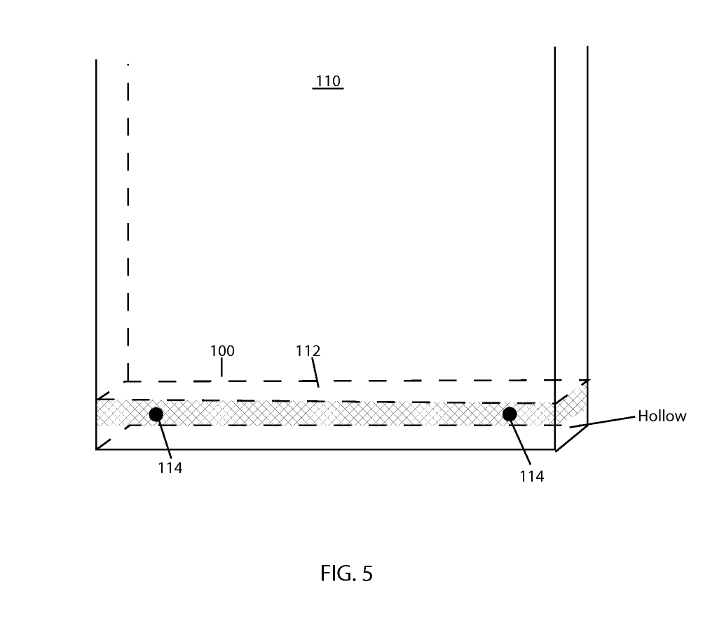

Another embodiment of the smoke guard made according to the principles of the present invention is illustrated in FIG. 5. This “stored-in-door” embodiment is especially useful for new builds or for when doors are being replaced. A metal door is used in this illustration, although the door could be of wood, plastic, or any other material of which doors are made. In this example, at least the bottom-most section of the interior of the door is hollow 116. Smoke guard 110, made according to the principles of the present invention, is installed within the hollow space at the bottom of the door during, or after, the manufacture of the door. The door is fashioned with two apertures through which handles, levers, or control buttons 114 are positioned. Handles 114 are attached to the top plate 112 of smoke guard 110 in such a manner that when a user pulls down on handles 114, the pulling force acts on top plate 100 to result in the transfer of smoke guard 110 to the floor. In this case, the compressible/re-expandable material is automatically placed into position to completely fill the gap between the bottom of the door and the floor. Smoke guard 110 is available with or without the magnetic strip and/or an application of intumescent.

Except for the “stored-in-door” model, smoke guard devices are available in their own container that is designed to hold the device until needed. So that the device is available when needed, it is able to be hung, or otherwise attached, to a wall or the back of a door. Smoke guards are also available in plastic-type bags, to be carried in a suit case for travelers to carry them when staying in buildings that may not have such a safeguard.

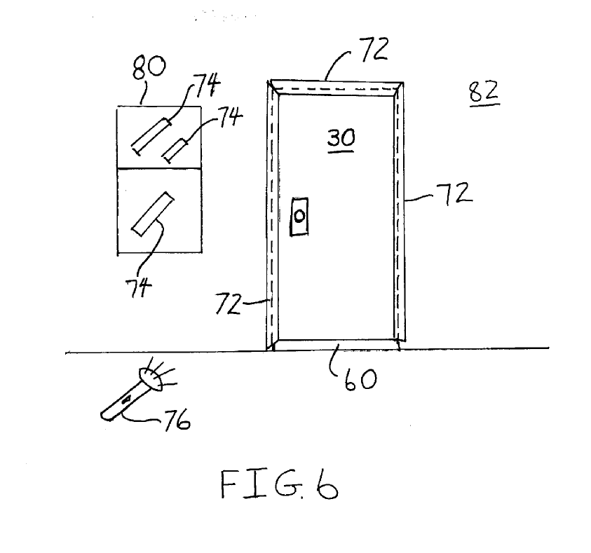

Some doors do not fit tightly in the confines of the door jam. In the event there are openings about the side or the top edges of the door, the smoke guard package includes self-adhering tape 72 that could be intumescent strips for placement over such openings, as illustrated in FIG. 6, where tape 72 positioned over the door top and side opening is adhered to both door 30 and wall 82. When exposed to heat intumescent strips expand to create an enhanced smoke barrier and also, as discussed above, upon expansion, the intumescent material releases water that reduces the temperature of the door. This is important in that most doors used in public building are only fire resistant rated from 20 minutes to 1½ hours. The smoke guard is rated for two or more hours, depending on the materials used in manufacture.

Many homes and apartments, hotels and hospitals are not in compliance with the requirements of the fire code. For example, hotels and tourist spots are infamous for not following the fire code requirements and for not maintaining their fire protection equipment properly. Having access to a smoke guard of the present invention is especially important in rooms from which there is no easy or safe egress. It is well-accepted that windows should not be opened in a fire because of the fire-drawing draft that an open window would create. Closed windows, however, may give one the feeling that no one knows that they are in the room and need to be rescued. To alleviate this concern, the smoke guard is available with strips of fluorescent tape 74, or the like, to be placed on a window 80 to provide notice to emergency personnel. Also available is small flashlight 76 to use if it is dark and the lights go out and to alert emergency personnel to the situation and/or a glow-light, especially one that is rated to last for 12 hours and requiring no batteries.

Thus, it can be seen from the above that the Applicant is teaching an inventive concept that supplies all of the principles needed to provide for smoke guard devices that offer the means to keep smoke and flame from entering a room through the space that is mandated to be between the bottom of a door and the floor. Additionally, the principles include intumescent tape to seal the non-air tight spaces at the sides and top of a door, as well as aids such as reflective tape and a battery to provide notice to those outside the building that a person is trapped in the room. Moreover, as the smoke guards and accessories of the present invention may be constructed of presented available and permitted materials, the cost to manufacture is minimal, thus making these essential safety features, affordable.

The foregoing description, for purposes of explanation, used specific and defined nomenclature to provide a thorough understanding of the invention. However, it will be apparent to one skilled in the art that the specific details are not required in order to practice the invention. The disclosed descriptions and illustrations are not intended to be exhaustive or to limit the invention to the precise forms disclosed. Those skilled in the art will recognize that many changes may be made to the features, embodiments, and methods of making the versions of the invention described herein without departing from the spirit and scope of the invention, such as adjusting the template patterns shown in the drawings and described above to fit the variety of other similar, but different, multi-dimensional expansion joints, as well as to fit the various sizes of multi-dimensional joints that require fire barriers. Furthermore, the present invention is not limited to the described methods, embodiments, features or combinations of features but include all the variation, methods, modifications, and combinations of features within the scope of the appended claims. The invention is limited only by the claims.

What is claimed is:

1. A device constructed of compressible/expandable material covered by a first end of a length of fire resistant cloth, said device so arranged that when said first end is inserted into a gap between the bottom of the door and the floor said device prevents smoke, poisonous gases, or fire from traversing the gap.

2. The device, as recited in claim 1, wherein said compressible/expandable material is foam.

3. The device, as recited in claim 2, wherein said foam is memory foam.

4. The device, as recited in claim 1, wherein said fire resistant cloth is impermeable to smoke and gas.

5. The device, as recited in claim 4, wherein said fire resistant cloth is impermeable to moisture.

6. The device, as recited in claim 1, further comprising intumescent material affixed to said device.

7. The device, as recited in claim 1, wherein a second end of said length of fire resistant cloth includes magnetic material arranged so as to attach said second end of said length of fire resistant cloth to a magnetic metal section of a door.

8. The device, as recited in claim 7, wherein said magnetic material is a piece of magnetic metal fixed to said second end of said length of fire resistant cloth.

9. The device, as recited in claim 7, wherein intumescent material is affixed to a central area of said length of fire resistant cloth.

10. The device, as recited in claim 9, wherein said intumescent material is self-adhering.

11. The device, as recited in claim 1, further comprising a second end of said length of fire resistant cloth comprising adhesive arranged so as to adhere second end of said length of fire resistant cloth to the door.

12. The device, as recited in claim 1, in combination with strips of self-adhering luminescent tape sized to be secured over door top and side openings.

13. The device, as recited in claim 1, wherein said device is rated for either one or two hours according to UL1784.

14. The device, as recited in claim 1, further comprising a carrying case for said device.

15. The device, as recited in claim 1, further comprising a carrying case for said device permitting said device to be folded for easy insertion into a suitcase.

16. The device, as recited in claim 1, in combination with strips of self-adhering luminescent tape sized to be secured over a window giving notice to fire-fighters.

17. The device, as recited in claim 1, in combination with a flashlight or a glow light giving notice to fire-fighters.

18. The device, as recited in claim 1, wherein said device is sized to fit with a hollow door to be released from the door in the event of a fire.

19. A device constructed of a length of fire resistant cloth having a first end and a second end, said first end wrapped about and affixed to a compressible/expandable material covered so that when said first end is inserted into a gap between the bottom of the door and the floor said device prevents any smoke from traversing the gap, said second end comprising either magnetic or adhesive adhering means so arranged as to adhere second end of said length of fire resistant cloth to the door, and a section of intumescent material affixed to a central area of said length of fire resistant cloth.

20. A kit containing:
A device constructed of a length of fire resistant cloth having a first end and a second end, said first end wrapped about and affixed to a compressible/expandable material covered so that when said first end is inserted into a gap between the bottom of the door and the floor said device prevents any smoke from traversing the gap, said second end comprising either magnetic or adhesive adhering means so arranged as to adhere second end of said length of fire resistant cloth to the door, and a section of intumescent material affixed to a central area of said length of fire resistant cloth, and strips of self-adhering luminescent tape sized to be secured over door top and side openings.
